(19) United States
(12) Patent Application Publication
(10) Pub. No.: US 2007/0086213 A1
(43) Pub. Date: Apr. 19, 2007

(54) Backlight module with interengaging frame and light guide plate and liquid crystal display device with same

(75) Inventor: Hsiang-Hui Hsieh, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/582,601

(22) Filed: Oct. 18, 2006

(30) Foreign Application Priority Data
Oct. 18, 2005 (CN) 200510100491.8

(51) Int. Cl. F21V 7/04

(52) U.S. Cl. 362/633

(57) ABSTRACT

An exemplary backlight module (200) includes a light guide plate (50) and a frame (80). The light guide plate includes a plurality of surfaces, and at least one of the surfaces each defines at least one groove (502) thereat. The frame includes a plurality of sidewalls, and at least two of the sidewalls each have at least one protrusion (802). The protrusions are engaged in the grooves fixing the light guide plate in the frame. In addition, an exemplary liquid crystal display is also provided.

### FIELD OF THE INVENTION

The invention relates to backlight modules, and liquid crystal display devices that use backlight modules.

### GENERAL BACKGROUND

Due to the non-self-emitting characteristic of liquid crystals of a liquid crystal display (LCD), a backlight module is commonly included in an LCD to provide an adequate and uniform flat light source to enable the LCD to display images.

A backlight module mainly includes a light source, a light guide plate (LGP) and a frame. The light source is positioned at the light entrance surface in relation to the LGP. The LGP directs the linear or point light emitted from the light source and transforms into a uniform flat light so as to display images. The frame is provided as a fixed support for the other components (e.g. diffusers, brightness enhancing films, and reflection sheets, etc.) of the backlight module. In conventional art, the frame and the LGP are connected by the protrusion of the LGP and the groove of the frame.

Referring to FIG. 10, an exploded view of a conventional backlight module 10 is illustrated. The backlight module includes a light guide plate (LGP) 11, a frame 12 for mounting the LGP 11, a reflection sheet 15, a printed circuit board (PCB) 14, and a plurality of light emitting elements 13 mounted at the PCB 14.

The LGP 11 includes a light exit surface 111, a light entrance surface 112 intersecting the light exit surface 111, a bottom surface 113 which is opposite to the light exit surface 111, and two opposing lateral surfaces 115 which are adjacent to the light entrance surface 112. The lateral surfaces 115 have six protrusions 114. A group of three protrusions 114 is located at each of the opposing lateral surfaces 115 and distributed symmetrically, and the thickness of the protrusion 114 is smaller than the thickness of the lateral surface 115. The four protrusions 114 located on both ends of each lateral surfaces 115 are at the same level to the light exit surface 111 and the intermediate two protrusions 114 are at the same level of the bottom surface 113. The frame 12 includes a plurality of openings 122 for embedding the light emitting elements 13 and six grooves 123. Those grooves 123 are set opposing to the protrusions 114 so that in connection with the grooves 123 and the protrusions 114 the LGP 11 can be fixed at the frame 12.

The backlight module 10 can be assembled by the following method. Firstly, the LGP 11 is mounted at the frame 12 so as to inset the protrusions 114 of the LGP 11 to the grooves 123 of the frame 12. Subsequently, the PCB 14 is set into the frame 12 so as to mount the light emitting elements 13 to the openings 122 of the frame 12. Finally, the reflection sheet 15 is set at the bottom surface 13 of the LGP 11.

The frame 12 is usually made of plastic, and the light emitting element 13 is usually a light emitting diode (LED).

However, the disadvantage of the thinner LGP 11 is that the thinner protrusions which might be difficult to be formed in the injection molding process. In particular, residual stress differentials may result in warpage and/or weakness of the LGP 11 and/or the protrusions.

Accordingly, what is needed is a backlight module configured to be able to be formed easily in the injection molding process.

### SUMMARY

An exemplary backlight module includes a light guide plate and a frame. The light guide plate includes a plurality of surfaces, and at least one of the surfaces each defines at least one groove thereat. The frame includes a plurality of sidewalls, and at least two of the sidewalls each have at least one protrusion. The protrusions are engaged in the grooves fixing the light guide plate in the frame.

The at least one protrusion is rectangular or trapezoidal in shape.

A detailed description of embodiments of the present invention is given below with reference to the accompanying drawings.

### BRIEF DESCRIPTION OF THE DRAWINGS

Embodiments of the invention can be more fully understood by reading the subsequent detailed description and examples with references made to the accompanying drawings. In the drawings, all the views are schematic.

FIG. 1 is an exploded view of a backlight module in accordance with a first embodiment of the present invention.

FIG. 2 is an assembled view of part of the backlight module shown in FIG. 1.

FIG. 3 is an enlarged side view of part of the backlight module taken along line III-III of FIG. 2.

FIG. 4 is an enlarged side view of part of the backlight module taken along line III-III of FIG. 2 assembled with a frame, a light guide plate, a reflect sheet, a diffuser and a brightness enhance film.

FIG. 5 is an enlarged side view of a backlight module in accordance with a second embodiment of the present invention.

FIG. 6 is an exploded view of a backlight module in accordance with a third embodiment of the present invention.

FIG. 7 is an exploded view of a backlight module in accordance with a fourth embodiment of the present invention.

FIG. 8 is an exploded view of a backlight module in accordance with a fifth embodiment of the present invention.

FIG. 9 is an exploded view of a liquid crystal display of the present invention.

FIG. 10 is an exploded view of a conventional backlight module.

### DETAILED DESCRIPTION OF PREFERRED EMBODIMENTS

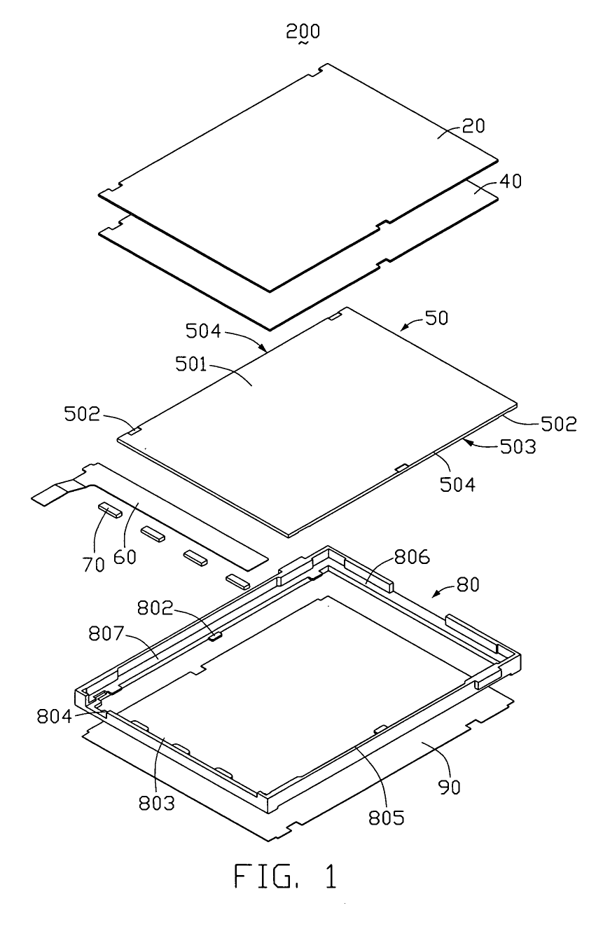

Referring to FIG. 1, illustrated an exploded view of a backlight module 200 in accordance with a first embodiment of the present invention. The backlight module 200 includes a brightness enhance film 20, a diffuser 40, a light guide plate (LGP) 50, a printed circuit board (PCB) 60, a plurality of light emitting elements 70 mounted at the PCB 60, a frame 80 for holding the LGP 50, and a reflection sheet 90.

The LGP 50 includes a light exit surface 501, a bottom surface 503 which is opposite to the light exit surface 501, two opposite lateral surfaces 504, and six grooves 502. Three of grooves 502 are located at the edge of light exit surface 501, also known as “the upper side” and the other three grooves 502 are located on the edge of bottom surface 503, also known as “the lower side”. The upper and the lower side grooves 502 are offset relative to each other.

The frame 80 includes a first sidewall 804, a second sidewall 805, a third sidewall 806 and a fourth sidewall 807. The sidewalls 804, 805, 806, 807 are used to hold the LGP 50. The first sidewall 804 has a plurality of openings 803 for embedding the light emitting elements 70 thereat. There are six protrusions 802 rectangular in shape on the second sidewall 805 and the fourth sidewall 807. The positions of the six protrusions 802 are corresponding to the grooves 502 on the LGP 50, such that by connection of the protrusions 802 in the grooves 502, the LGP 50 can be fixed into the frame 80.

In the preferred embodiment, the foregoing PCB 60 can be a flexible printed circuit (also known as FPC). The light emitting element 70 can be a light emitting diode (LED), and the frame 80 can be made of plastic.

The protrusions 802 are set on the frame 80. Generally, the frame 80 is injected from a pin-point gate which has several runners. In comparison with conventional techniques, to set protrusions 802 on the frame 80 according to the present invention is easier for injection molding.

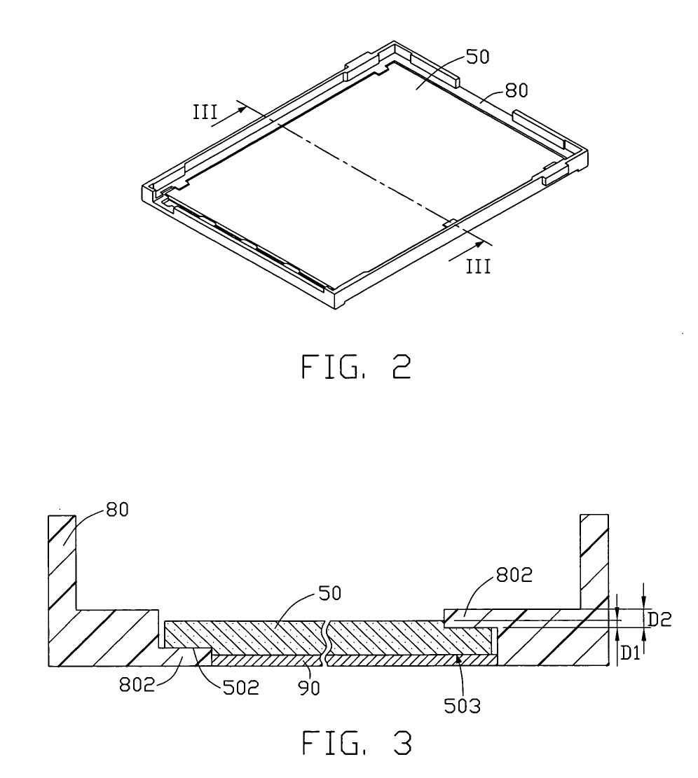

Referring to FIGS. 2 and 3, the thickness D2 of protrusion 802 is greater than the thickness D1 of groove 502. In the preferred embodiment, the thickness D1 is 0.1 mm (or thinner) and the thickness D2 is 0.3 mm. In fabrication, the groove 502 is connected with the protrusion 802 that the LGP can be fixed into the frame 80. Subsequently, the reflection sheet 90 is set at the bottom surface 503 of the LGP 50. While combining the reflection sheet 90 to the LGP 50, the surface of the reflection sheet 90 can be substantial at the same level with the protrusion 802.

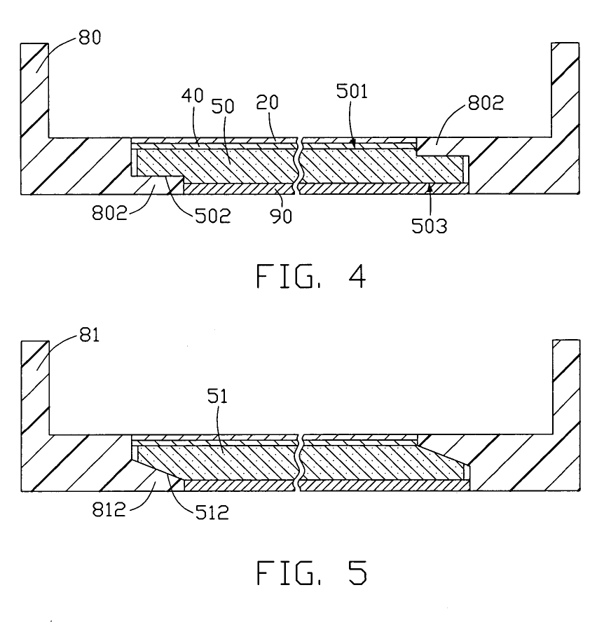

Referring to FIG. 4, the diffuser 40 and brightness enhance film 20 are set sequentially at the light exit surface 501 of the LGP 50. While combining the diffuser 40 and the brightness enhance film 20 to the LGP 50, the surface of the brightness enhance film 20 can be substantially at the same level with the protrusion 802.

It should be noted that there is no protrusion on the LGP 50 then during the mold releasing process for the LGP 50, it is easier to release without deformation. On the other hand, the structure of the LGP 50 is simpler than the conventional technique (with protrusion on the edge of the LGP) that there is much less residual stress remaining on the LGP. Accordingly, the thinner LGP can be achieved so as to reduce the whole thickness of the backlight module. Therefore, the thickness D1 of the groove 502 on the LGP 50 can be smaller than 0.1 mm and the optical characteristics are not affected without protrusions on the LGP. Additionally, the protrusions 802 are set on the frame 80. Generally, the molding for the frame making is injected from pin-point gate with several runners that in compare with the conventional technique, to set protrusions on the frame, the present invention is much easier for injection molding. The thickness D2 of protrusion 802 can be larger than 0.3 mm. Although the thickness D2 is larger than D1, in connection with the frame 80 and the LGP 50 and combining with other optical films, the total thickness are not change. Consequently, the protrusion 802 can provide sufficient strength for the structure so as to fix the LGP 50 on the frame 80 effectively.

Referring to FIG. 5, illustrated an enlarged side view of a backlight module in accordance with a second embodiment of the present invention. The difference between first embodiment and second embodiment is that the shape of the protrusion 812 of the frame 81 can be trapezoid, and shape of the LGP 51 is corresponding with thereof.

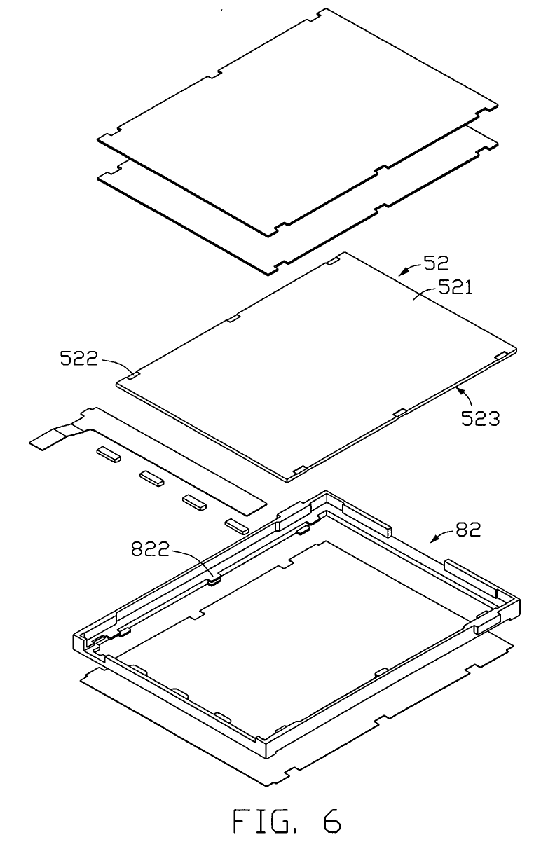

Referring to FIG. 6, illustrated an exploded view of a backlight module 300 in accordance with a third embodiment of the present invention. The difference between first embodiment and third embodiment is that the LGP 52 includes twelve grooves 522 also known as six pairs and set correspondingly with each other. In each pair grooves, one may be set on the edge of light exit surface 521 and the other may be set on the edge of bottom surface 523 alternatively. For the four pair grooves of the two end of the LGP 52, the position of the upper side (also known as the light exit side) grooves and the lower side (also known as the bottom side) grooves may be interlaced with each other. Furthermore, the intermediate grooves on the LGP 52 are set as opposite dual.

Relatively, the frame 82 also includes twelve protrusions 822 that the protrusions 822 of the frame 82 can link up the grooves 522 on the LGP so as to fix the LGP 50 into the frame 82.

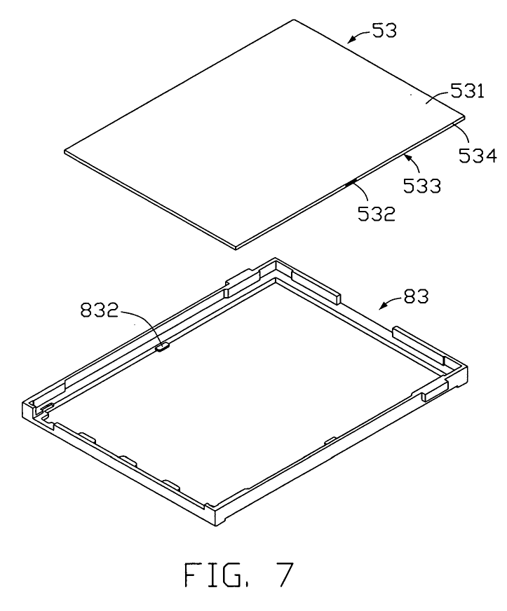

Referring to FIG. 7, illustrated a schematic view of backlight module according to the fourth embodiment of the present invention. The difference between first embodiment and fourth embodiment is that each opposite lateral surfaces 534 of the LGP 53 may set one groove 532 symmetrically and respectively. Each groove 532 is located between the light exit surface 531 and the bottom surface 533. Furthermore, the thickness of the groove 532 is smaller than the thickness of the LGP 53.

Relatively, the frame 83 includes two protrusions 832. The location of the two protrusions 832 relates to the location of the two grooves 532 on the LGP 53 that the protrusion 832 can be inserted to the groove 532 while combining the LGP 53 to the frame 83.

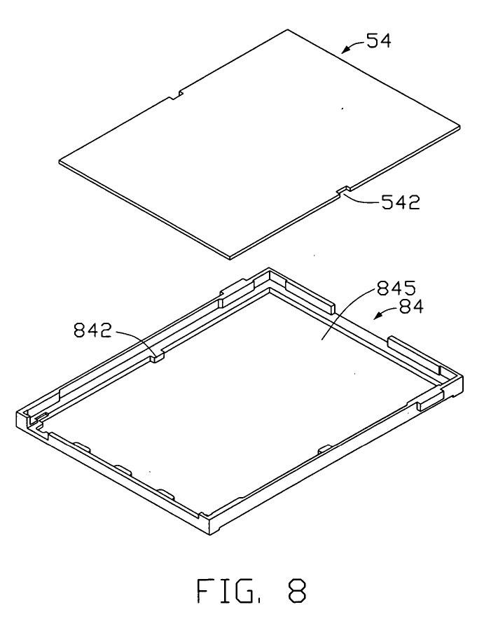

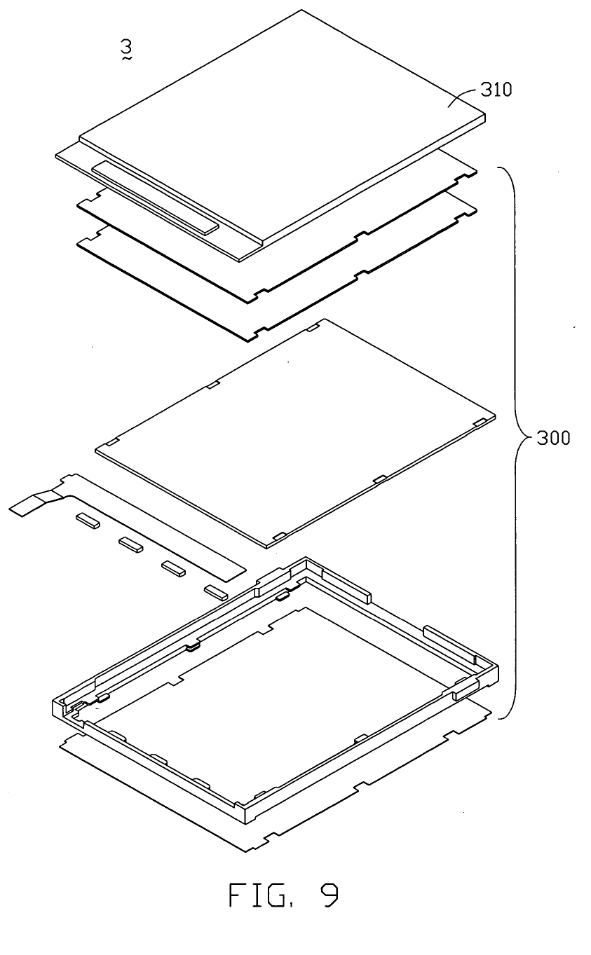

Referring to FIG. 8, an exploded view of a backlight module in accordance with a fifth embodiment of the present invention is illustrated. The difference between the fourth embodiment and the fifth embodiment is that the frame 84 here further may include a bottom plate 845. The thickness of the groove 542 is substantially identical to the thickness of the LGP 54 that the groove 542 penetrates the lateral edge of the LGP 54.

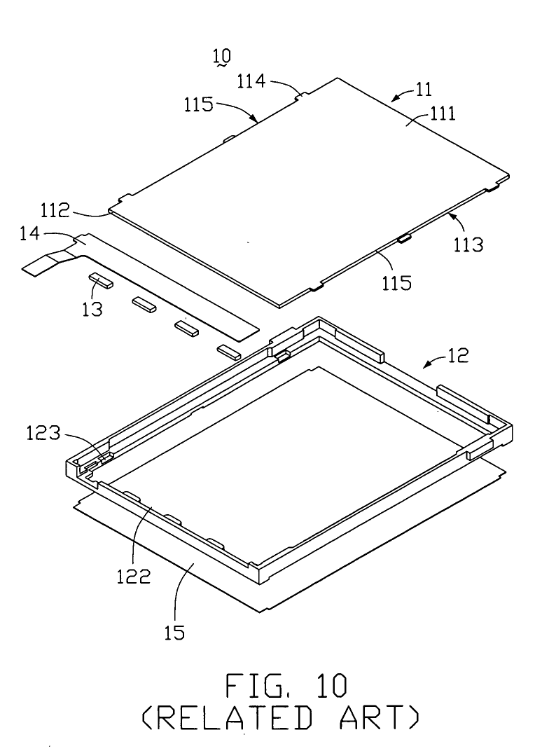

Referring to FIG. 9, a liquid crystal display 3 includes the aforementioned backlight module 300 and a liquid crystal panel 310 which is set at opposite side of the backlight module 300.

While the invention has been described by way of examples and in terms of preferred embodiments, it is to be understood that the invention is not limited thereto. To the contrary, the above description is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A backlight module, comprising:
a light guide plate comprising a plurality of surfaces, at least two of the surfaces each defining at least one groove thereat; and
a frame comprising a plurality of sidewalls, at least two of the sidewalls each having at least one protrusion;
wherein the protrusions are engaged in the grooves, thereby fixing the light guide plate in the frame.

2. The backlight module as claimed in claim 1, wherein the plurality of surfaces of the light guide plate includes a light exit surface, a bottom surface opposite to the light exit surface, and a plurality of lateral surfaces between the light exit surface and the bottom surface.

3. The backlight module as claimed in claim 2, wherein one of the at least one grooves is located at an edge of the light exit surface or at an edge of the bottom surface.

4. The backlight module as claimed in claim 2, wherein the one of the at least one grooves has a depth less than a thickness of the light guide plate.

5. The backlight module as claimed in claim 2, wherein the at least one groove is at least two grooves, one of the at least two grooves is located at an edge of the light exit surface, and another of the at least two grooves is located at an edge of the bottom surface.

6. The backlight module as claimed in claim 2, wherein one of the at least one grooves is located at one of the lateral surfaces, and the one of the at least one grooves spans from the light exit surface to the bottom surface.

7. The backlight module as claimed in claim 2, wherein one of the at least one grooves is located at one of the lateral surfaces, and is located between and spaced from both the light exit surface to the bottom surface.

8. The backlight module as claimed in claim 1, wherein a thickness of the at least one protrusion is greater than a thickness of the at least one groove.

9. The backlight module as claimed in claim 8, wherein the thickness of the at least one groove is no greater than 0.1 mm.

10. The backlight module as claimed in claim 1, wherein the at least one protrusion is rectangular or trapezoidal in shape.

11. A liquid crystal display comprising:
a liquid crystal panel; and
a backlight module adjacent the liquid crystal panel, and the backlight module comprising:
a light guide plate comprising a plurality of surfaces, at least two of the surfaces each defining at least one groove there at; and
a frame comprising a plurality of sidewalls, at least two of the sidewalls each having at least one protrusion;
wherein the protrusions are engaged in the grooves thereby fixing the light guide plate in the frame.

12. The liquid crystal display as claimed in claim 11, wherein the plurality of surfaces of the light guide plate includes a light exit surface, a bottom surface opposite to the light exit surface, and a plurality of lateral surfaces between the light exit surface and the bottom surface.

13. The liquid crystal display as claimed in claim 12, wherein one of the at least one grooves is located at an edge of the light exit surface or at an edge of the bottom surface.

14. The liquid crystal display as claimed in claim 12, wherein the one of the at least one grooves has a depth less than a thickness of the light guide plate.

15. The liquid crystal display as claimed in claim 12, the at least one groove is at least two grooves, one of the at least two grooves is located at an edge of the light exit surface, and another of the at least two grooves is located at an edge of the bottom surface.

16. The liquid crystal display as claimed in claim 12, wherein the groove is set on the lateral and the groove penetrates the light exit surface and the bottom surface.

17. The liquid crystal display as claimed in claim 12, wherein one of the at least one grooves is located at one of the lateral surfaces, and is located between and spaced from both the light exit surface to the bottom surface.

18. The liquid crystal display as claimed in claim 11, wherein a thickness of said the at least one protrusion is greater than a thickness of the at least one groove.

19. The liquid crystal display as claimed in claim 18, wherein the thickness of the at least one groove is no greater than 0.1 mm.

20. The liquid crystal display as claimed in claim 1, wherein the neighboring protrusions on the same side walls are located at different levels, and the neighboring protrusion on the opposite side walls are located at different levels.
